(19) United States
(12) Patent Application Publication
(10) Pub. No.: US 2009/0006489 A1
(43) Pub. Date: Jan. 1, 2009

(54) HIERARCHICAL SYNCHRONIZATION OF REPLICAS

(75) Inventors: Venugopalan Saraswati Ramasubramanian, Mountain View, CA (US); Thomas L. Rodeheffer, Mountain View, CA (US); Douglas B. Terry, San Carlos, CA (US); Edward P. Wobber, Menlo Park, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/771,273

(22) Filed: Jun. 29, 2007

(51) Int. Cl. G06F 17/30

(52) U.S. Cl. 707/201; 707/E17.005

(57) ABSTRACT

A hierarchical system is disclosed for synchronizing partially-replicated collections that provides guaranteed paths of information to all replicas in a collection. Each partial replica is assigned a parent replica to act as a proxy on its behalf, and with which the replica synchronizes regularly. Each parent replica is responsible for one or more child replicas. Parent replicas have filters which are either the same as, or more inclusive than, their child replicas, and parent replicas thus store and synchronize all objects that are of interest to their one or more child replicas.

### CROSS-REFERENCE TO RELATED APPLICATION

The following applications are cross-referenced and incorporated by reference herein in their entirety:

U.S. patent application Ser. No. 11/751,478 [MS# 318994.01], entitled “Item-Set Knowledge for Partial Replica Synchronization,” by Ramasubramanian, et al., filed on May 21, 2007.

U.S. patent application Ser. No. ______ [MS# 319749.01], entitled “Move-In/Move-Out Notification for Partial Replica Synchronization,” by Ramasubramanian, et al., filed on the same day as the current application.

### BACKGROUND

In a collection of computing devices, a data item may be multiply replicated to create a number of copies of the item on the different computing devices and/or possibly within a single device. An item may be any stored data object, such as for example contact or calendar information, stored pictures or music files, software application programs, files or routines, etc. The collection of computing devices may for example be a desktop computer, a remote central server, a personal digital assistant (PDA), a cellular telephone, etc. The group of all such items and replicas where the items are stored may be referred to as a distributed collection.

In many cases, a user would like all of their various data storing devices to have the latest updated information without having to manually input the same changes into each device data store. Replication, or synchronization, of data is one process used to ensure that each data store has the same information. Synchronization protocols are the means by which devices exchange created and updated versions of items in order to bring themselves into a mutually consistent state. The periodicity of the sync may vary greatly. Networked devices may sync with each other frequently, such as once every minute, hour, day, etc. Alternatively, devices may sync infrequently, such as for example where a portable computing device is remote and disconnected from a network for a longer period of time. Whether the synchronization is frequent or infrequent, the distributed collection is said to be weakly-consistent in that, in any given instant, devices may have differing views of the collection of items because items updated at one device may not yet be known to other devices.

As an example, a user may maintain an electronic address book or a set of email messages in a variety of different devices or locations. The user may maintain the address book or email addresses, for example, on a desktop computer, on their laptop computer, on a personal digital assistant (PDA) and/or mobile phone. The user may modify the contact information or send/receive email addresses using applications associated with each location. Regardless of where or how a change is made, one goal of replication is to ensure that a change made on a particular device or in a particular location is ultimately reflected in the data stores of the other devices and in the other locations.

FIG. 1 illustrates a weakly-consistent distributed collection, including multiple replicas A-F. Each replica A-F may be a computing device including a data store and associated processor. However, as is known, a single computing device may include several replicas, and a single replica may be implemented using more than one computing device. In the example of FIG. 1, the replicas may include a desktop computer A, a pair of laptop computers B and C, a cellular telephone D, a personal digital assistant (PDA) E and a digital camera F. The number and type of replicas is by way of example and may be more, less and/or different than shown. FIG. 1 further shows communication links 22 (represented by dashed lines) between the various replicas to establish a peer-to-peer network. It may often be the case that not all replicas are linked to all other replicas. For example, laptop B is linked to desktop A, laptop C, cellular phone D and PDA E, but not digital camera F. Consequently, laptop B can sync with digital camera F only through one or more intermediate sync steps involving replicas C or E. The illustrated communication links can be wired and/or wireless links.

Synchronization between replicas may be described as a sharing of knowledge between replicas. A common knowledge sharing scheme involves tracking, within each replica, changes that have occurred to one or more items subsequent to a previous replication. One such tracking scheme makes use of version vectors, which consist of list of version numbers, one per replica, where each version number is an increasing count of updates made to an item by a replica. During synchronization, one replica sends version vectors for all of its stored items to another replica, which uses these received version vectors to determine which updated items it is missing. Comparing the version vectors of two copies of an item tells whether one copy is more up-to-date (every version number in the up-to-date copy is greater than or equal to the corresponding version number in the other copy) or whether the two copies conflict (the version vectors are incomparable). The replica may then update its copy of the item if required or make efforts to resolve the detected conflict.

Although version vectors enable replicas to synchronize correctly, they introduce overhead. The version vector of each item may take O(N) space in an N replica replication system, thus requiring O(M*N) space across an M item collection. This space requirement could be substantial if the number of items is large and could approach the size of the items themselves if items are small. Similarly, exchanging version vectors during synchronization consumes bandwidth. Even if two replicas have fully consistent data stores, they still need to send a complete list of version vectors whenever they periodically perform synchronization.

Another knowledge sharing scheme, implemented for example in the WinFS data storage and management system from Microsoft Corp., makes use of knowledge vectors. Unlike version vectors, knowledge vectors are associated with the replicas rather than the items. Each replica keeps a count of the updates it generates, and the knowledge vector of a replica consists of the version number of the latest update it learned from every other replica. In addition, items at a replica have a single version number indicating the latest update applied to it. Replicas exchange knowledge vectors during synchronization, determine and exchange the missing updates, and change their knowledge vector to reflect the newly-learned knowledge (each number is set to the maximum of the corresponding numbers in the two knowledge vectors of the synchronizing replicas).

An example of knowledge sharing between a pair of replicas using knowledge vectors is illustrated with respect to prior art FIGS. 2 and 3. In the example of FIGS. 2 and 3, replica A is synching with replica B. Replica A has a data store 24 and a knowledge vector 26, K_{A}. The data store 24 contains a set of replicated items. The knowledge vector in replica A includes one or more pairs of replica IDs together with update counters, which together represent what knowledge replica A has about changes that have occurred to items in the collection. For example, knowledge vector K_{A} may have the components:

### K_{A}=A5 B3 C7.

This means that replica A has knowledge including changes up to the 5^{th} change in replica A, the 3^{rd} change in replica B, and the 7^{th} change in replica C.

Each of the changes indicated in the knowledge vector may be represented in the set of replicated items. For example, assume four items in the collection, identified by unique identifiers i, j, l and m. The set of items stored in data store 24 at Replica A may look as follows:

TABLE 1

| Item | | |
|---|---|---|
| Unique ID | Version | Data |
| i | A2 | . . . |
| j | C7 | . . . |
| l | A5 | . . . |
| m | B3 | . . . |

The data store thus indicates, for a given item, which version was produced when that item was last changed (i.e. the item was created, modified or deleted) as far as this replica is aware, and the data showing the actual updated contents (not shown in Table 1). Thus, for example, replica A knows that the 7^{th} change in replica C was to item j, and it includes the data associated with the change to item j.

Similarly, replica B has a data store 24 and a knowledge vector 26, K_{B}. The knowledge vector in replica B represents what knowledge replica B has about changes that have occurred to items in the collection. For example, knowledge vector K_{B} may have the components:

### K_{B}=A2 B5 C8.

This means that replica B has knowledge including changes up to the 2^{nd} change in replica A, the 5^{th} change in replica B and the 8^{th} change in replica C. Each of these changes is represented in the set of items stored by replica B.

Referring now to prior art FIG. 3, at time 1, replica A sends a sync request along with replica A's knowledge, which may be represented by replica A's knowledge vector, to replica B. At time 2, replica B examines replica A's knowledge by comparing the respective knowledge vectors. Replica B discovers that replica A is not aware of changes made by replica B that are labeled with the version B5, or changes made by replica C (which are known to replica B) that are labeled with the version C8. Thus, replica B sends the items with these versions. Subsequently or simultaneously as illustrated in time 3, replica B sends to replica A replica B's learned knowledge.

As this is a one-way synchronization, this ends the sync process resulting from replica A's sync request (in a two way sync, the process would be repeated with replica B receiving changes from replica A and learning what knowledge replica A has). Replica A can update its knowledge vector based on the learned knowledge and received changes to include the recently replicated changes as shown in Replica A in FIG. 3.

Knowledge vectors impose substantially lower overhead compared to version vectors. The space required per replica to store knowledge vectors is just O(N+M), including the space required for per item version numbers, compared to O(N*M) for version vectors, where the system has N replicas and the replica has M items. Further more, exchanging knowledge vectors only requires O(N) bandwidth compared to O(N*M) for exchanging version vectors.

While knowledge vectors work well for total replication between replicas, it may happen that one or more replicas are only interested in receiving a certain subset of information. This situation is referred to as partial replication. For example, suppose the data store includes email messages in various folders, including an inbox folder and some number of other folders including, perhaps, folders that contain saved email messages. In some cases a user might want to replicate changes to all of the email folders. For example, this might be desirable when the communications bandwidth between replicating devices is large. In other cases—perhaps when the bandwidth is limited, as it might be at some times with a mobile phone or PDA—the user might only want to replicate changes to a particular folder, like their inbox.

It is also conceivable that a user might want to synchronize only part of their entire set of data in all cases. For example, a user might want to maintain all email on a desktop computer or server, but only synchronize their inbox and a selected set of folders to a small device that has limited storage. In this case, some information may never be synchronized with a particular device.

As another example, for a data store that includes digital music files, a user might want to synchronize their entire digital music library-perhaps they have a portable music player or computer with a large hard drive. They may also have a small portable music player with a limited amount of flash memory, on which they only want to store a selected set of music. In one example, this music to be synchronized might include, for example, digital music files the user has rated with “four stars” or “five stars,” as well as music downloaded in the last week.

In order to allow for partial replication in the above situations, as well as a wide variety of others, a replica may contain a filter. A “filter” may be broadly defined as any construct that serves to identify a particular set of items in a data collection. These items are said to fall within the partial replica's “interest set”. When synchronizing in a partial replication scenario, like in the situations introduced above, various additional problems may occur. These problems include the following:

Efficient knowledge sharing: A partial replica is interested in only a certain subset of items and consequently has knowledge that is limited by its interest set. When a partial replica shares its knowledge with a second replica, the second replica must somehow account for this limitation. This is not a problem for a version vector knowledge sharing scheme, which maintains knowledge about each item separately. However, a knowledge vector knowledge sharing scheme maintains its knowledge vector about the replica as a whole rather than about each item separately. This results in a substantial savings in storage and bandwidth as compared with version vectors, but it also makes it a problem to account for a limited interest set.

Partial information: In order for a replica to eventually learn about an item within its interest set, it requires a synchronization path to all other replicas that are interested in the same item. Moreover, each intermediate replica in the synchronization path must also be interested in the item. Otherwise, a replica may not receive complete information about all the items it is interested in. For example, in FIG. 1, if the camera F takes a picture that the cell phone D wants to use as a background but the laptop C and the PDA E are not interested in the picture then the cell phone D has no way of obtaining it with its existing synchronization topology.

Push outs: When a partial replica updates an item, the updated item may no longer fall within the replica's interest set. Although the partial replica would like to discard such an item, it may find itself in the situation of holding the only copy, in which case discarding the updated item would cause the update to evaporate from the collection. In this situation, the partial replica must “push out” the item to another replica before discarding it. A similar situation can arise when a partial replica alters its filter. For example in FIG. 1, while a user might take a large number of pictures with digital camera F, perhaps the user desires a policy of storing only the most recent 100 pictures on the camera because of its limited storage. Such a policy could be effected by altering the camera's filter each time a new picture is taken so as to exclude an old picture. However, camera F can safely discard the old picture only if there is a guarantee that the picture is stored elsewhere. This could be done by transferring the picture to another replica during synchronization. However, ensuring such transfers eventually result in durable storage for the pictures is difficult with arbitrary synchronization topologies.

Move outs: When a partial replica is the target of a synchronization, the source replica may be aware of an update to an item for which an old version is stored by the partial replica, but the new version does not fall within the partial replica's interest set. The partial replica needs to be made aware that the item it stores has been updated so as to “move out” of its interest set. For example, in FIG. 1, suppose that Laptop B stores a full calendar of all baseball games and cell phone D is interested in storing only weekend games. A weekend game moves to a week day and the user at Laptop B updates the item accordingly. When cell phone D next synchronizes from Laptop B, it must receive a “move-out” notification.

Reincarnation: When a replica deletes an item, the system needs to ensure that all copies of that item are permanently deleted from the system. If not, the deleted copy might get resurrected at a later point of time based on an old version. Resurrection of deleted items is a concern even without considering partial replicas. Partial replicas add the related problem that an item discarded due to a move-out might be “reincarnated” from an old version synced from an out-of-date replica.

Filter Changes: Finally, replicas may change filters at any time causing some items to move out of the interest set as well as disrupt the path of information flow the replica relies on to learn new items. It is desirable to ensure that filter changes do not disrupt information flow and items discarded during filter changes are completely expunged without the risk of resurrections.

Except for the problem of efficient knowledge sharing, a reason for the above problems is that arbitrary synchronization topologies do not provide a guaranteed path of information flow for replicas. A solution to provide guaranteed information paths is to have one or more replicas serve as reference replicas, which replicate all the items in the system, and have replicas synchronize with a reference replica periodically. However, it may not be always possible for all replicas to synchronize with reference replicas. Moreover, reference replicas may not be reachable at a dire time of need.

### SUMMARY

The present technology, roughly described, relates to a system using item-set knowledge and a hierarchical arrangement of replicas to allow synchronization of partially-replicated collections while keeping synchronization overhead low by using the concept of item-set knowledge. Item-set knowledge consists of one or more knowledge fragments, which associate knowledge vectors with sets of items, called item-sets, instead of the whole replica. An item-set consists of an explicitly represented list of unique item identifiers. In a partial replica, this item-set may be the items known to a replica for which a filter is applied limiting the items known to some subset of the overall items in the collection.

Embodiments of the present system relate to a hierarchical approach to perform synchronization that provides guaranteed paths of information to all replicas in a collection. Each partial replica is assigned a “parent” replica to act as a proxy on its behalf, and with which the partial replica regularly synchronizes as both source and target. The parent is either a reference replica or a partial replica with an interest set greater than or equal to that of the child. Each parent replica thus stores and synchronizes all items that are of interest to its one or more children replicas. Of course, if a parent replica is itself a partial replica, it in turn has its own parent replica. Following such a chain of parent replicas eventually leads to a reference replica.

Reference replicas need not have parents, although they must regularly synchronize with each other in a way that forms a connected topology among all reference replicas. The parent-child relationship between replicas in the collection creates a hierarchical synchronization topology rooted at one or more reference replicas.

The hierarchical topology augments, but does not supplant ad hoc synchronization. In addition to the required sync operations between parent and child replicas, replicas are still free to synchronize with arbitrary peers as they would in a general weakly-connected replication system.

### BRIEF DESCRIPTION OF THE DRAWINGS

FIG. 1 is weakly-consistent distributed collection according to the prior art.

FIG. 2 shows a pair of replicas A and B and their respective knowledge according to the prior art.

FIG. 3 show a synchronization operation between replicas A and B according to the prior art.

FIG. 4 is weakly-consistent distributed collection including one or more partial replicas according to embodiments of the present system.

FIG. 5 shows a replica A including data store, push out store, knowledge, filter, and hierarchy information according to embodiments of the present system.

FIG. 6 shows a one-way synchronization operation between a pair of replicas A and B according to the present system.

FIG. 7 shows the replicas A and B of FIG. 6 after the one-way synchronization operation according to the present system.

FIG. 8 shows replica B requesting a one-way synchronization operation with a replica C, where replica C includes an item that has moved out of the scope of interest of replica B due to a change in the item.

FIG. 9 shows the one-way synchronization between replicas B and C of FIG. 8, including a move-out notification being sent to replica B.

FIG. 10 shows the one-way synchronization between replicas B and C of FIG. 8, including learned knowledge being sent to replica B.

FIG. 11 illustrates a one-way synchronization between replicas B and A, illustrating a potential problem of an outdated item being reincarnated within to a replica.

FIG. 12 shows the one-way synchronization between replicas B and C including a move-out notification being sent to replica B as in FIG. 8, and further including replica B storing class II knowledge of the move-out.

FIG. 13 shows the one-way synchronization between replicas B and C of FIG. 12, including learned knowledge being sent to replica B.

FIG. 14 shows a one-way synchronization operation between replicas B and A where move-out data is indicated by Class II knowledge.

FIG. 15 shows the one-way synchronization between replicas B and A of FIG. 14, including learned class I and class II knowledge being sent to replica B.

FIG. 16 shows a tree structure hierarchical synchronization topology of replicas according to embodiments of the present system.

FIG. 17 shows a directed acyclic graph structure hierarchical synchronization topology of replicas according to embodiments of the present system.

FIG. 18 shows a split filter hierarchical synchronization topology of replicas according to embodiments of the present system.

FIG. 19 gives a flowchart of a method for increasing a replica's star knowledge through synchronization with descendant and ancestor replicas.

FIG. 20 is a block diagram of a computing system environment according to an embodiment of the present system.

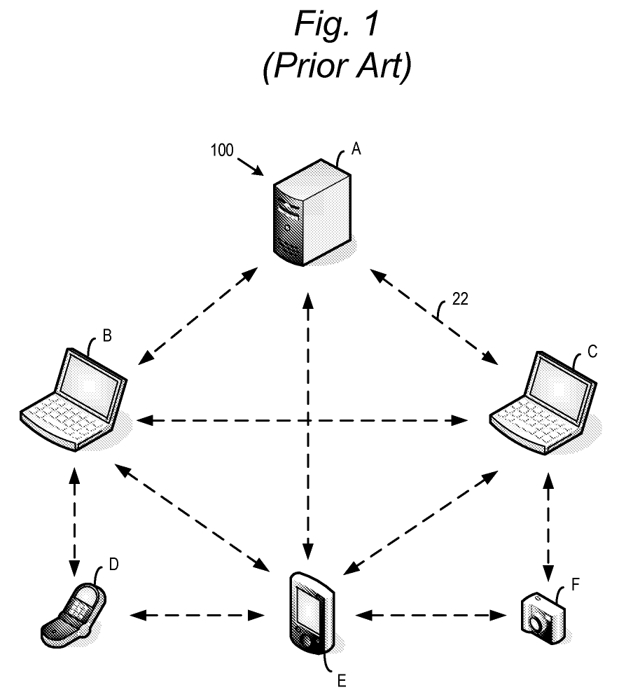

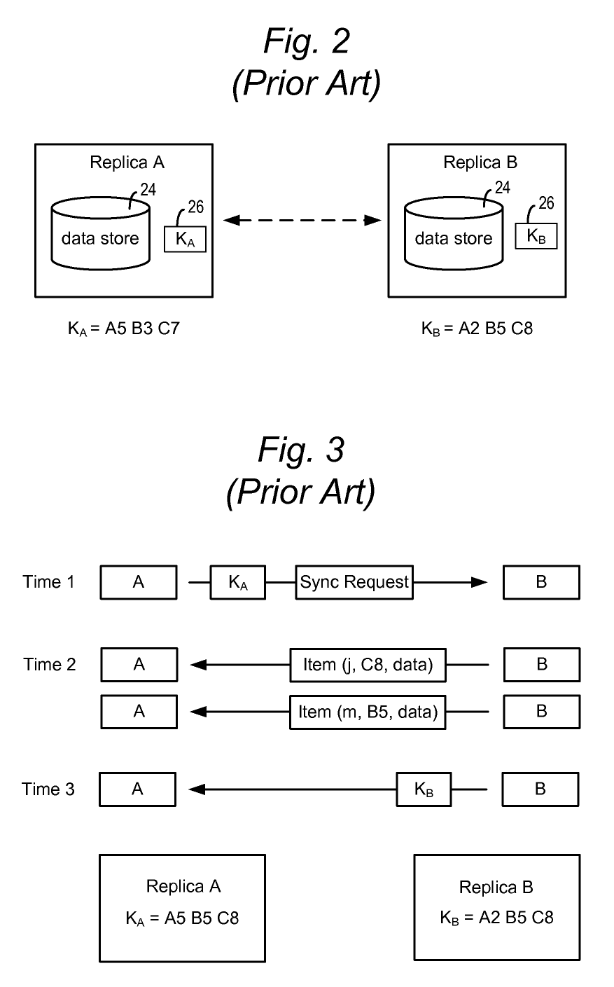

### DETAILED DESCRIPTION

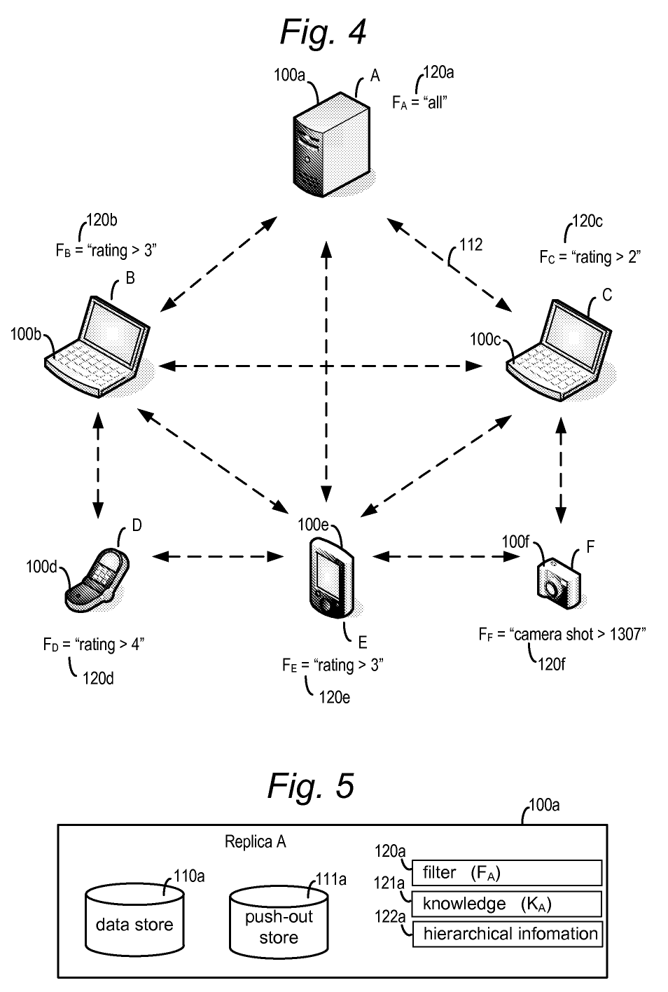

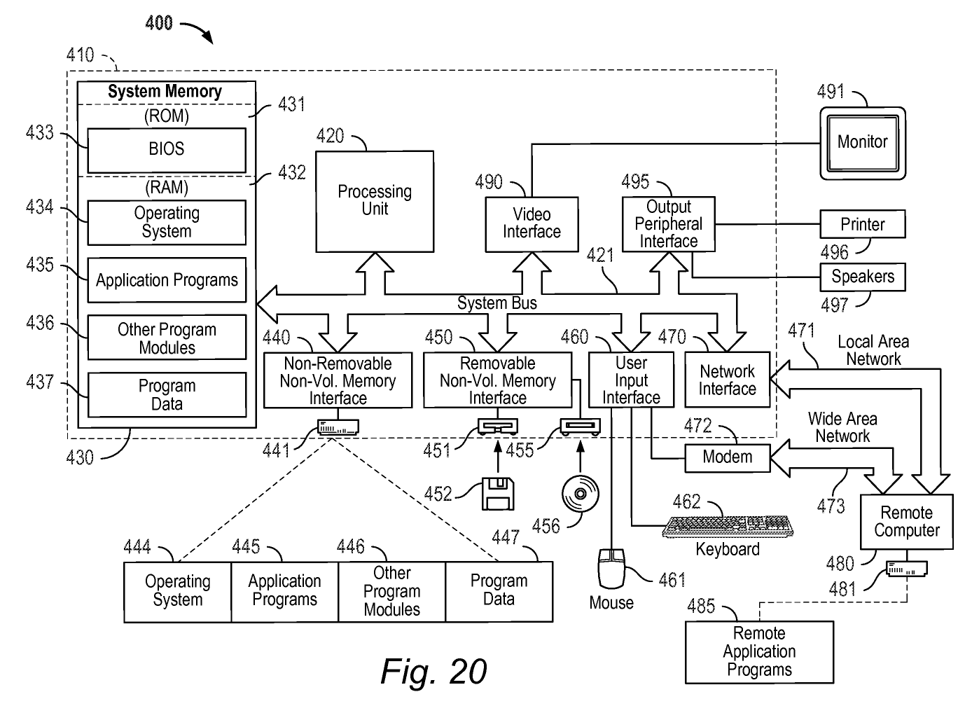

The present system will now be described with reference to FIGS. 4-20, which in general relate to synchronization in partial-replication systems. The system may be implemented on a distributed computing environment, including for example one or more desktop personal computers, laptops, handheld computers, personal digital assistants (PDAs), cellular telephones, multiprocessor systems, microprocessor-based systems, programmable consumer electronics, minicomputers, and/or other such computing system environments. Details relating to one such computing system environment are explained hereinafter with respect to FIG. 20. Two or more of the computing system environments may be continuously and/or intermittently connected to each other via a network such as peer-to-peer or other type of network as is known in the art.

Referring initially to FIGS. 4 and 5, the system includes a plurality of replicas 100a-f, arbitrarily referred to herein as replicas A through F. The designation replica 100 is used when discussing a replica in general without regard to which particular one it might be, and likewise for other components. Each replica 100 may create and/or modify a version of an item in a collection. A replica may be a computing system environment. However, multiple replicas may exist on a single computing system environment, and a single replica may exist across multiple computing system environments. Each replica 100 may include a data store 110 associated with a processor on one or more computing system environments mentioned above or as known in the art. Each data store 110 may store data associated with items in the collection. Each replica 100 may include a push-out store 111 associated with a processor on one or more computing system environments mentioned above or as known in the art. Each replica 100 may include knowledge 121 indicating which versions of an item the replica is aware of. Each replica 100 may additionally include a filter 120 to define a subset of items the replica is interested in receiving. Each replica 100 may additional include hierarchical information 122 about the location of the replica 100 in a hierarchical synchronization topology. Details about the push-out store 111 and hierarchical information 122 will be provided hereinafter. The processor can create a new item, modify an item to produce a new version, place versions into the data store 110 and discard versions from the data store 110. The processor can also place versions into the push-out store 111, discard versions from the push-out store 111, and transfer versions between the data store 110 and the push-out store 111. As is obvious to those skilled in the art, an alternative embodiment could employ one store for both the data store 110 and the push-out store 111 by associating with each version an indication of whether the version belonged in the data store 110 or in the push-out store 111.

In the example of FIG. 4, the replicas 100 may include a desktop computer A, a pair of laptop computers B and C, a cellular telephone D, a personal digital assistant (PDA) E and a digital camera F. The number and type of replicas comprising the collection shown in the figures is by way of example and there may be greater, fewer or different replicas in the collection than is shown. Moreover, the total membership of the collection does not necessarily need to be known to any given replica at any given time. Each replica in the sync community has a unique ID, which may be a global unique identifier (GUID) in one embodiment.

Each replica 100 is shown with a corresponding filter 120 that specifies the interest set of the replica. In the example of FIG. 4, these filters are illustrated as based on certain example attributes of a photo in a photo collection. In this example, camera F takes photos, assigning a “camera shot number” to each photo. Since the user wants his recent pictures to be available on the camera, the camera has a filter specifying that it is interested in all camera shots after number 1307. The other example attribute illustrated in FIG. 4 is a user-assigned subjective “rating” of 1 to 5 stars. The number and type of the attributes and the filters shown in the figures is by way of example and there may be greater, fewer, or different attributes and filters in the collection than is shown. For example, perhaps cell phone D could also take photos.

The replicas may communicate with each other in an ad hoc, peer-to-peer network via communication links 112 (represented by dashed lines) between the various replicas. It may be that not all replicas are linked to all other replicas. For example, laptop B is linked to desktop A, laptop C, cellular phone D, PDA E, but not digital camera F. Consequently, laptop B can sync with digital camera F only through one or more intermediate sync steps with replicas A and C through E. The illustrated communication links can be wired and/or wireless links, and may or may not include the Internet, a LAN, a WLAN or any of a variety of other networks.

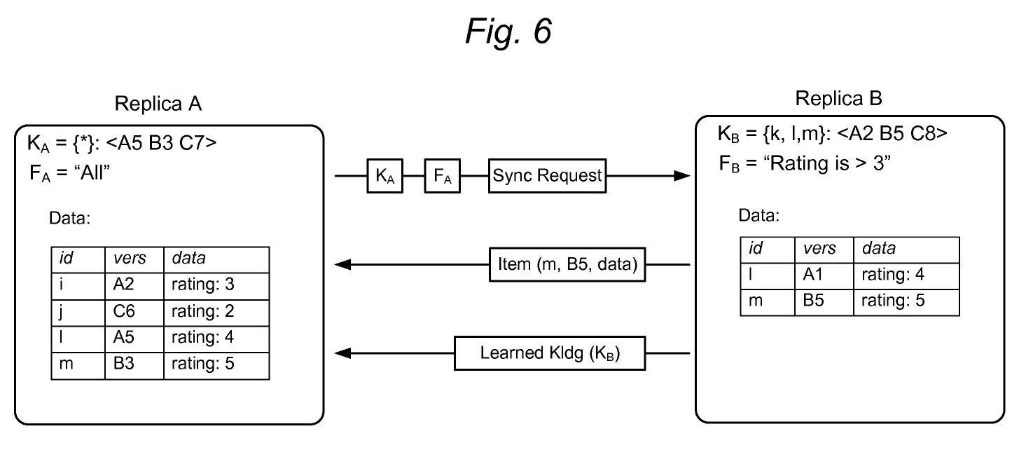

Referring now to FIG. 6, there is shown an example of replication between two replicas using a filter. The example shown in FIG. 6 is a one-way synchronization. Namely, there is an initiating replica requesting the sync (in this example, replica A), and a source replica which is contacted to provide updated information (in this example, replica B). In this example, replica B determines updated items replica A is not aware of, and transmits those updated items to replica A. From the point of view of transmitting items, replica B is the sending replica and replica A is the receiving replica.

While the figures and following description indicate a particular order of execution, the operations and/or their order may vary in alternative embodiments. For example, a pair of replicas could sync one-way, exchange roles, and sync the other way, thus performing a two-way synchronization. Furthermore, in some implementations, some or all of the steps may be combined or executed contemporaneously. In the example of FIG. 6, replica A includes knowledge K_{A} and a set of data items. Similarly, replica B includes knowledge K_{B} and a set of items.

In accordance with the present system, the concept of item-set knowledge, as explained below, may be used to sync partial replicas with low synchronization overhead. Partial replicas are those in which a filter may be specified or provided during a synchronization request. A filter is any construct that serves to identify a particular set of items of local interest to a replica and which get stored in a replica's data store. A filter may select items from the data collection based on their contents or metadata. A filter may be a SQL query over tabular data or an XPath expression over XML representations of items or any other type of content-based predicate.

An item may fall within a filter at one time, but due to a subsequent change in the item, may fall outside the filter at another time. An example would be as follows. Consider partial replica B in FIG. 4, which has a filter that selects “all photos having a rating of three or more stars”. In this example, when using a replica in the collection, a user may ascribe a photo a rating of three stars. Thus, upon synchronization, replica B would accept this photo. However, subsequently, the user or another authorized user may downgrade the rating of the photo to two stars. At that time, replica B would want to learn that the downgraded photo was no longer of interest and it would not be interested in further updates, unless the photo was again upgraded to three stars or more.

In some embodiments, the filter itself may be transmitted as part of the sync request. In other embodiments, the filter may be stored elsewhere and only some means of identifying the filter may be transmitted as part of the sync request. In yet other embodiments, certain types of sync requests may automatically result in the use of certain filters, in which case the filter itself may not be transmitted with the sync request. For example, a sync request transmitted over a low bandwidth connection might automatically result in the use of a filter that in some way reduces the number or nature of the items or changes returned.

Item-set knowledge associates knowledge vectors with item-sets, instead of with the whole replica. Each replica stores one or more knowledge fragments consisting of an explicitly represented list of items and an associated knowledge vector as well as version numbers for each item similar to the knowledge vector scheme. Item-set knowledge represents an intermediate position between the two extreme cases of per-item version vectors and knowledge vectors in terms of space and bandwidth consumption. In the best case, the item-set knowledge may just require one fragment to cover the knowledge of all the items in the replica, while in the worst case, it may require a separate fragment for each item in the replica.

Each replica's knowledge is a set of knowledge fragments. Each knowledge fragment consists of two parts: an explicit set of items (indicated by their GUIDs) and an associated set of versions represented by a knowledge vector. In addition, the latest version number for each item needs to be maintained separately by the replica. This is similar to the case of knowledge vectors. The semantics are that, for any item in the item-set, the replica is aware of any versions included in the associated knowledge vector. Knowledge fragments are additive, i.e. a replica knows about a specific version of a specific item if any of its knowledge fragments includes the item in the item-set and the version in the associated knowledge vector. A knowledge vector may include versions for items that are not in the associated item-set, in which case nothing can be concluded about these versions.

As a special case, a knowledge fragment may refer to the universal set of all items without needing to list all possible GUIDs. Such a knowledge fragment is called “star knowledge”. Having star knowledge means that the replica is aware of all updates performed by each listed replica up to the corresponding version number in the knowledge vector.

A replica holds knowledge about items that it currently stores. This first type of knowledge is called “class I knowledge”. In addition, a partial replica may be aware of items that it does not store because the current version of the item is outside its scope of interest. This second type of knowledge is called “class II knowledge”. Further details relating to class II knowledge are set forth hereinafter. As an alternative embodiment, a partial replica may store a “place holder” to represent an item that is outside its scope of interest. In this alternative embodiment, knowledge of place holders corresponds to class II knowledge.

A replica initiating synchronization sends all of its knowledge fragments (both class I and class II) to the source replica, which returns, in addition to updated items, one or more knowledge fragments as learned knowledge.

When an item is created with a new version generated by the creating replica, this version is added to the replica's class I knowledge. If the replica has a single class I knowledge fragment, the process is straightforward. The new item's ID is added to the knowledge fragment's item-set and the new version is added to the fragment's knowledge vector. If the replica has multiple class I knowledge fragments, then several options are possible. One option is to create a new knowledge fragment for the new item. This may result in many small knowledge fragments. An alternative is to add the new item and version to all of the knowledge fragments. A still further alternative is to choose one knowledge fragment to which the new item is added. The fragment that is selected may be the one that has the largest item-set or the fragment with the maximal knowledge.

When an item is updated locally, the new version number is simply added to the knowledge vector of the knowledge fragment that includes the item in its item-set. Optionally, it could be added to all knowledge fragments. A partial replica can choose to discard any item that it stores. For example, a partial replica will generally discard items that are updated and no longer match its filter. In such a case, the ID of the discarded item could be simply removed from the item-set of the class I knowledge fragment(s) that contain this item. If the item-set is empty, i.e. it only contained this single item, then the whole knowledge fragment may be discarded. If the version of the removed item does not match the partial replica's filter, it may be retained as class II knowledge.

Replicas may change their filters. If a partial replica modifies its filter, i.e. changes the predicate that selects items of local interest, then in the general case it must discard all of its class II knowledge, because it has no way of knowing whether those items match its new filter or not. However, if the new filter is more restrictive than the old filter, meaning that all items excluded by the old filter are also excluded by the new filter, then the class II knowledge is still valid and need not be discarded.

At the end of a synchronization session, the sending replica transmits as learned knowledge all of its knowledge fragments. However, items that may match the filter predicate provided by the receiving replica but are not stored by the sending replica are removed from the item-sets of the learned knowledge fragments. In practice, this means that class II knowledge will not be returned as learned knowledge unless the sending replica is a full replica or is a partial replica whose filter matches anything that would be selected by the receiving replica's filter. Learned knowledge fragments that are received at the completion of a synchronization session are simply added to the receiving replica's knowledge. Redundant fragments can be discarded as discussed below.

Thus, referring now to FIG. 6, there is shown a replica A requesting a sync with a replica B. Each replica is said to have a knowledge fragment S:K, where S is an explicit set of items, or “*” for all items, indicating star knowledge. K is a knowledge vector. A knowledge fragment for a given replica, S:K, is interpreted as the given replica has knowledge about all versions in K for all items in S. Replica A is a full replica; that is, has no filter, with knowledge consisting of a single knowledge fragment:

K_{A}={*}: <A5 B3 C7>

representing knowledge about items i, j, l and m having various associated ratings 2 through 5. Furthermore, since this is star knowledge, replica A knows that no other items were created or updated by any of the replicas A, B, and C up to the corresponding version numbers 5, 3, and 7.

In the example of FIG. 6, replica B has a filter relating to the rating of items. In particular, replica B accepts items having a rating of >3. The items may relate to anything capable of being rated, such as for example data relating to movies, books, videos, etc. Replica B has a knowledge fragment:

K_{B}={l,m}: <A2 B5 C8>

representing knowledge about items l and m which have ratings >3.

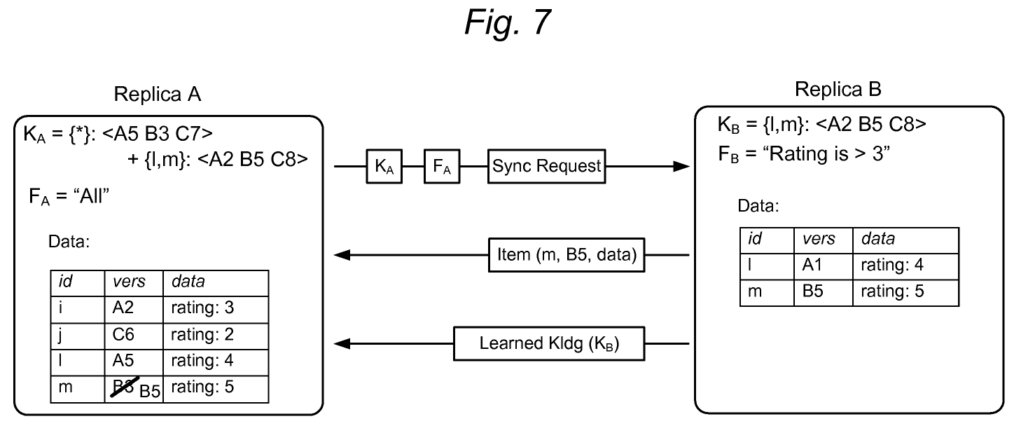

Upon requesting the sync, replica A sends its knowledge, K_{A} and its filter, F_{A}. Replica B learns that replica A is unaware of version B5 and determines that the item with this version matches replica A's filter. Therefore, replica B returns version B5 and associated data to replica A. As shown in FIG. 7, the version B3 in replica A is updated to B5. In the process of adding version B5 to its data store, replica A may detect an update conflict using known techniques for conflict detection. Known conflict resolution techniques may be applied in cases where neither update to a given item is the most recent.

Lastly, replica B returns the learned knowledge K_{B}. That is, as shown in FIG. 7, replica A learns about versions in K_{B} for items l and m. Thus after the sync, as shown in FIG. 7, replica A has two knowledge fragments:

K_{A}={*}: <A5 B3 C7>+{l,m}: <A2 B5 C8>.

This process may be repeated for each synchronization between replicas within the collection. In this example, replica B returned its complete knowledge as learned knowledge. However, in general, a replica should only return learned knowledge for items it stores that match the requesting replica's filter or for versions of items that it knows do not match the filter.

Synchronization between replicas may cause a replica's knowledge to partition into multiple knowledge fragments for subsets of items in the original item-set. For example, as seen in FIGS. 6 and 7, if replica A synchronizes with replica B interested in a subset of items of replica A's interest, then an item-set in replica A's knowledge may split into two sets, one covering the updates received from replica B and another for items not known to replica B.

Similarly, synchronization may cause multiple knowledge fragments to be discarded and/or merged into a single fragment with an item-set covering all the items in the original item-sets. For example, if replica B in the previous example synchronizes with replica A and replica A has a knowledge fragment that includes all of replica B's items with superior knowledge, then replica B could just replace its knowledge with the single fragment received from replica A. Table 2 below specifies how a replica may merge or reduce the size of two knowledge fragments, one knowledge fragment with item-set S₁ and knowledge vector K₁ and a second knowledge fragment with item-set S₂ and knowledge vector K₂.

TABLE 2
S₁:K₁ + S₂:K₂

[symbol]

| | S₁ ⊂ S₂? | S₁ = S₂? | S₂ ⊂ S₁? | S₁ ≠ S₂? |
|---|---|---|---|---|
| K₁ ⊂ K₂? | S₂:K₂ | S₂:K₂ | S₂:K₂ + S₁ − S₂:K₁ | S₂:K₂ + S₁ − S₂:K₁ |
| K₁ = K₂? | S₂:K₂ | S₁:K₁ | S₁:K₁ | S₁ ∪ S₂:K₁ |
| K₂ ⊂ K₁? | S₁:K₁ + S₂ − S₁:K₂ | S₁:K₁ | S₁:K₁ | S₁:K₁ + S₂ − S₁:K₂ |
| K₁ ≠ K₂? | S₁:K₁ ∪ K₂ + S₂ − S₁:K₂ | S₁:K₁ ∪ K₂ | S₂:K₁ ∪ K₂ + S₁ − S₂:K₁ | S₁:K₁ + S₂:K₂ |

Operations on S₁ and S₂ represent standard set operations and operations on K₁ and K₂ represent standard knowledge vector operations, except that ≠ is used to mean “incomparable”, that is, neither includes the other. Where K₂ properly includes K₁ (K₂ “dominates” K₁), and S₂ includes S₁, the S₁:K₁ knowledge fragment may be discarded and the result is S₂:K₂ (first row, first and second columns of table 2). Vice-versa where K₁ dominates K₂ and S₁ includes S₂ (third row, second and third columns). Where K₁ equals K₂ and S₂ dominates S₁, the resulting knowledge fragment is S₂:K₂ (second row, first column). Where K₁ equals K₂ and S₁ includes S₂, the resulting knowledge fragment is S₁:K₁ (second row, second and third columns). The remaining possible additive combinations result in some union or subtraction of either the items-sets or knowledge vectors, except for the case where K₁ and K₂ are incomparable and S₁ and S₂ are incomparable. In this case (fourth row, fourth column), there is no discard or merge and the resulting knowledge fragment is S₁:K₁+S₂:K₂. A union on two knowledge vectors (such as for example in the fourth row, first column) results in a new knowledge vector with the highest numbered version in the two vectors for each replica. Examples of synchronization and subsequent defragmentation of knowledge fragments is set forth in U.S. patent application Ser. No. 11/751,478, previously incorporated by reference.

As indicated above, replicas with knowledge of all items are said to have “star knowledge.” Conceptually, star knowledge is just an item set knowledge fragment U:K_{U} that covers the universal set U of items in the system; the set of items is implicit in the definition and need not be stored or communicated explicitly. Full replicas may represent their knowledge as a single star knowledge fragment, which avoids the need to explicitly list all of the items in the replicated data collection. Partial replicas can also use star knowledge in some cases. Star knowledge enables replicas to defragment item sets and ensure that the space and bandwidth consumed by item-sets remains low. Star knowledge may include the versions of items a partial replica is interested in keeping in its data store as well as versions of items the replica does not store and knows for sure fall outside its scope of interest. Note that replicas may have star knowledge in addition to other item-set knowledge fragments.

In embodiments, defragmentation involving a replica having star knowledge may take place according to table 3. This table shows how using star knowledge U:K_{U} leads to smaller or fewer item sets by illustrating a merge between item set S:K and U:K_{U}.

TABLE 3
S₁:K₁ + U:Kᵤ

[symbol]

| | S₁ ⊂ U? | S₁ = U? |
|---|---|---|
| K₁ ⊂ Kᵤ? | U:Kᵤ | U:Kᵤ |
| K₁ = Kᵤ? | U:Kᵤ | U:Kᵤ |
| Kᵤ ⊂ K₁? | S₁:K₁ + U:Kᵤ | U:K₁ |
| K₁ ≠ Kᵤ? | S₁:K₁ ∪ Kᵤ + U:Kᵤ | U:K₁ ∪ Kᵤ |

The item sets in table 3 merge only when star knowledge is higher than the knowledge fragments in the item sets. Thus in order to continuously defragment split item sets, replicas need to accumulate recent star knowledge.

A method for accumulating star knowledge in a replication system is as follows: each replica speaks for itself in terms of star knowledge, that is, the latest version number issued by a replica represents the star knowledge component for that replica. A replica can accumulate star knowledge components for other replicas by individually synchronizing with every other replica and learning their most recent version numbers. For the above mechanism to work, replicas do not discard items it created or changed. Replicas also need to retain knowledge of discarded items, and not the items themselves, by keeping a place holder for discarded items or by keeping separate item sets to represent learned-knowledge for discarded items (called class-II knowledge). A replica may expunge a place holder or class-II knowledge of a discarded item only after ensuring that every other replica's star knowledge subsumes the current replica's version number in the discarded item's knowledge. More structured forms of synchronization are contemplated in alternative embodiments.

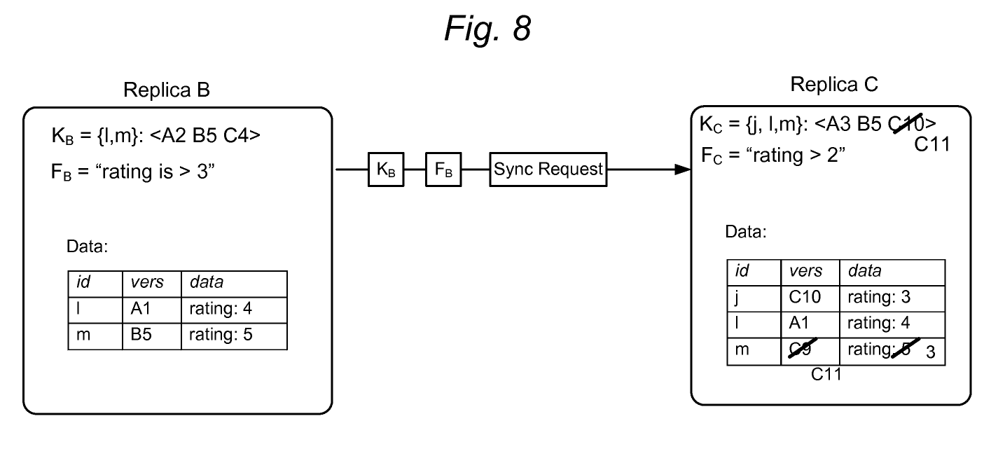

As indicated above, a concern in a system for synchronizing partial replicas is the so-called move-out scenario, where an item moves out of the scope of interest of a replica due to a change in the item performed elsewhere. Such a scenario is illustrated in FIG. 8. In FIG. 8, replica C updates item m to change its rating from a 5 to a 3. The version of item m is updated as C11 as shown in FIG. 8. Replica B has filter F_{B} of “rating is >3,” and has item m stored with its outdated rating of 5. Upon replica C changing item m from a rating of 5 to a rating of 3, item m now falls outside of the interest set of replica B. However, unless replica B receives some notification that item m has changed, the old value for item m will improperly remain within replica B.

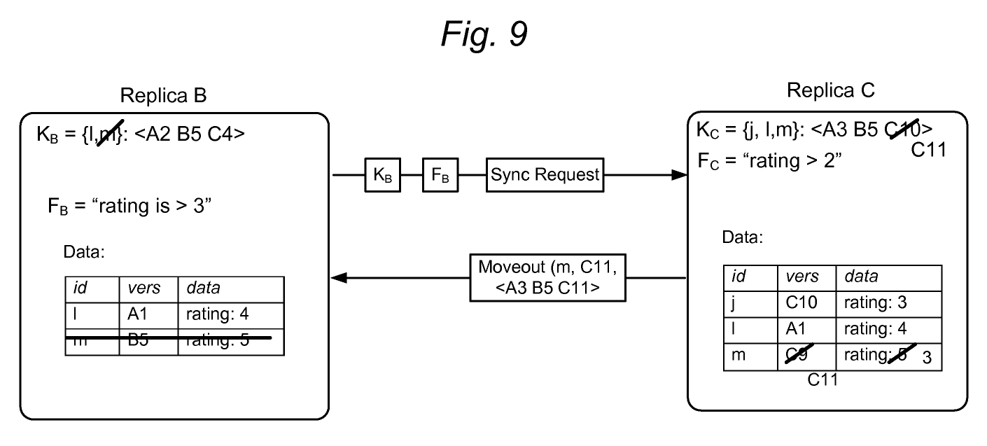

According to embodiments of the present system, as shown in FIG. 9, when an item moves out of the scope of interest of a replica due to a modification of the item, that replica receives notification of that move-out. As shown in FIG. 9, upon receiving the sync request, knowledge fragment and filter from replica B, replica C returns a move-out notification in addition to any versions that replica C knows of that replica B does not (in FIG. 9, no such versions exist). The move-out notification includes the item which has been modified to be outside of the interest set of replica B, the version showing modification and the updated knowledge fragment from the source replica C. Thus, in the embodiment of FIG. 9, the move-out notification sends item m, version C11, and knowledge fragment <A3 B5 C11>.

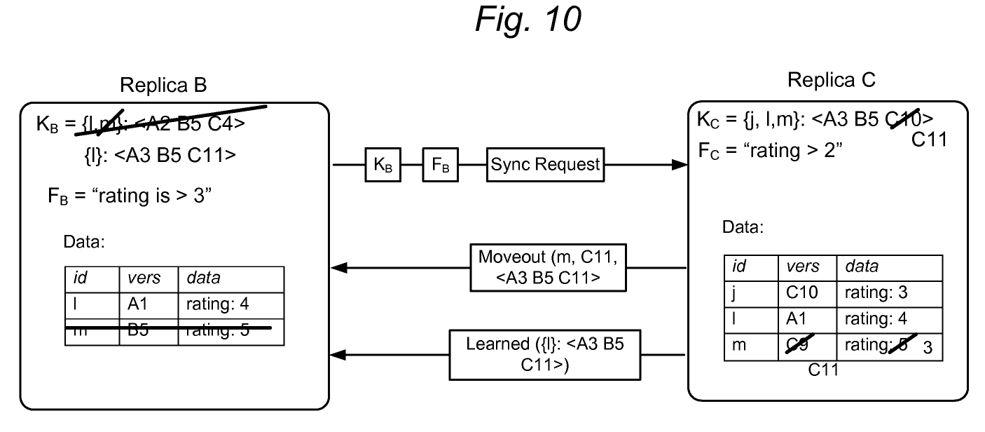

Replica B receives move-out notification and, in embodiments, removes item m from its data as shown in FIG. 9. Replica B also removes item m from its one or more knowledge fragment as shown in FIG. 9. Referring now to FIG. 10, after sending the move-out notification as well as any versions that the target replica is unaware of, the source replica may then send its learned knowledge as described above. In the example of FIGS. 8 through 10, replica C would send learned knowledge of: {l}: <A3 B5 C11>. As described above, items j and m from replica C are not sent in the learned knowledge in this embodiment, as their rating falls outside of the interest set defined by the filter F_{B} in replica B. The knowledge fragment K_{B} in replica B is thus updated to {l}: <A3 B5 C11> as shown in FIG. 10.

In general, a source replica will send a move-out notification to a target replica upon a change in an item if: 1) the source replica stores the item, 2) the source replica's version is later than the target replica's version, and 3) the changed item's contents are outside of the interest set defined by the target replica's filter. Alternatively, a source replica can inform a target replica of a move-out if: 1) the source replica does not store the item, but 2) the source replica's filter is less restrictive than the target replica's filter and 3) the source replica's knowledge is greater than the target replica's knowledge.

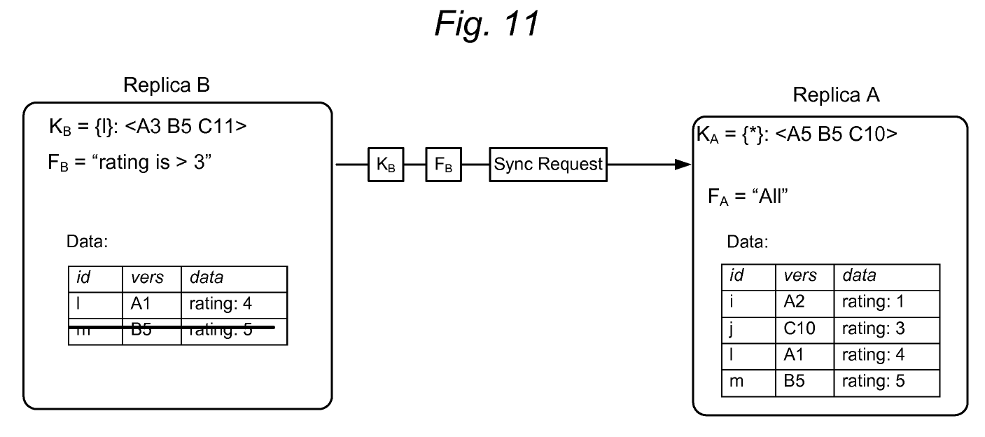

The above-described system operates effectively to provide move-out notification to all replicas in a weakly consistent distributed collection. However, the above-described methodology does not, by itself, address the issue of item reincarnation, in a partially replicated weakly consistent distributed collection. The problem of item reincarnation is illustrated in FIG. 11. In FIG. 11, replica B is shown after the sync operation and move-out notification with replica C described with respect to FIGS. 8 through 10. Replica B next requests a one-way synchronization operation with replica A. As shown, replica A has not yet learned of the update to item m. If the sync operation were allowed to go forward using only the information known to replicas A and B indicated in FIG. 11, outdated item m would be returned, or reincarnated, in replica B.

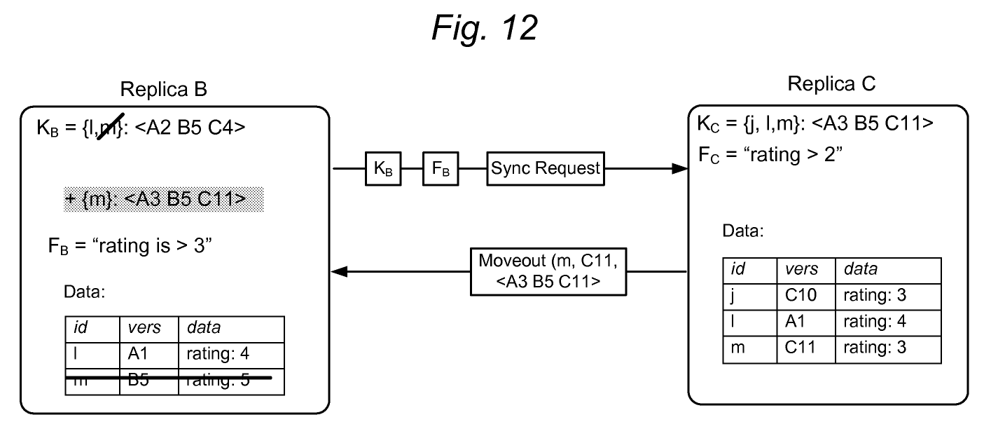

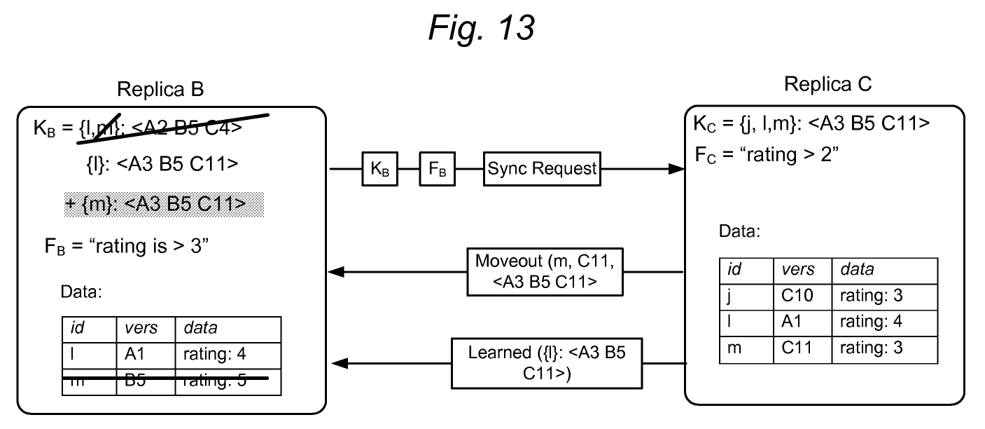

Accordingly, referring now to FIG. 12, when replica C sends the move-out notification as described above with respect to FIG. 9, and item m is removed from the interest set of stored data in replica B, a knowledge fragment representing item m is instead stored as class II knowledge in replica B. Class II knowledge is represented with shaded text in FIGS. 13 through 15. As described above, a replica holds knowledge about items that it currently stores. This first type of knowledge is called class I knowledge. In addition, a partial replica may maintain knowledge fragment representing items that it does not store, referred to herein as class II knowledge. A replica may store class II knowledge for an item where the current version of the item is outside the interest set of the replica. As an alternative embodiment, a partial replica may store a “place holder” to represent an item that is outside its scope of interest. In this alternative embodiment, knowledge of place holders corresponds to class II knowledge.

Storing class II knowledge prevents the reincarnation scenario shown in FIG. 9 by preventing items currently outside of the interest set of a partial replica from being received from other replicas in subsequent synchronization operations. Without class II knowledge, an out-of-date sending replica could send the partial replica an old version of an item that subsequently was updated and removed from the partial replica's scope of interest. By maintaining class II knowledge, the partial replica remains aware of the update, even though it does not store the item, and thus can prevent the old version from reappearing in its data store. If and when an item's rating changes to fall within a replica's interest set, then the item is stored in the replica and moved from the class II knowledge for that replica to class I knowledge for that replica.

Since no item is outside the scope of interest of a full replica, a full replica has no need for class II knowledge.

According to embodiments of the present system, as shown in FIG. 12, upon item m being modified to be outside of the interest set of replica B, when replica B receives the move-out notification, item m is removed from the interest set of replica B. Additionally, knowledge fragment K_{B} is updated to include class II knowledge of the removal ({m}: <A3 B5 C11>). Thereafter, as shown in FIG. 13, the sync operation is completed by replica B receiving the learned knowledge from replica C. The learned knowledge is added to replica B's knowledge, resulting in:

K_{B}={l}: <A2 B5 C4> (class I knowledge)+{m}: <A3 B5 C11> (class II knowledge.

After the sync operation shown in FIG. 13, replica B may next request to synchronize with replica A. As explained above, replica B initiates a sync operation by sending a sync request as well as its knowledge fragment and filter to replica A. The knowledge fragment sent by replica B includes both class I knowledge and class II knowledge.

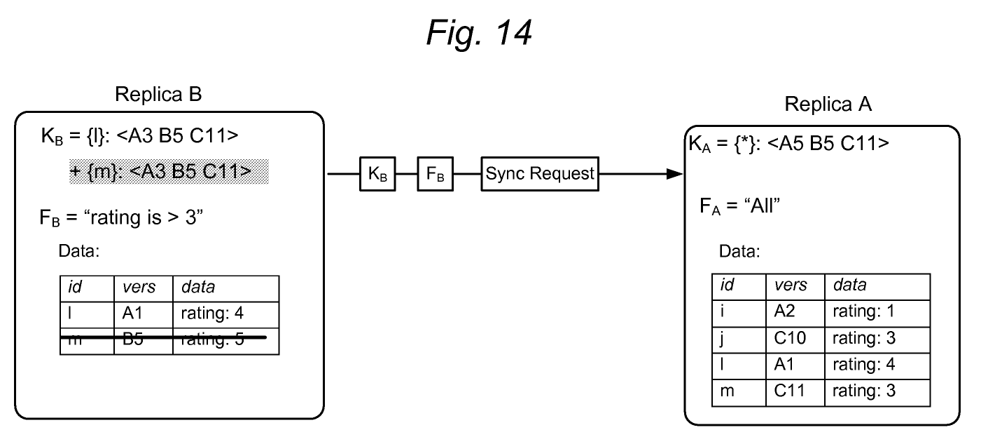

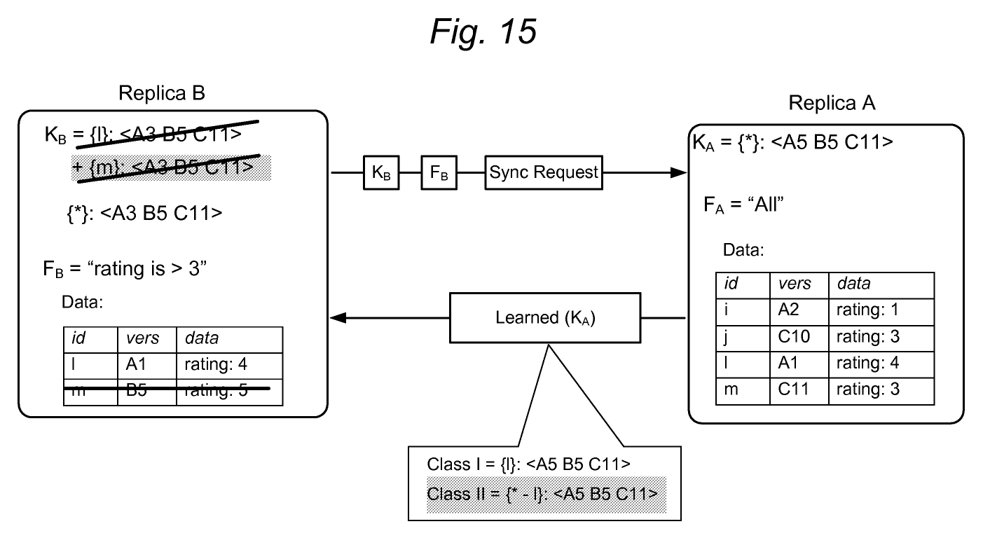

Source replica A then returns any versions of which it is aware and which replica B is not (there are no such versions in the example of FIGS. 14 and 15). As shown in FIG. 15, replica A then sends its learned knowledge. Viewing replica B's filter of F_{B} equal “rating is >3” the only item in replica A which falls within the interest set of replica B is item l. Accordingly, replica A returns as class I learned knowledge the knowledge vector associated with item l: {l}: <A5 B5 C11>. The remaining items in replica A all are outside of the interest set of replica B. However, in accordance with this embodiment, these items are all sent to replica B as class II learned knowledge: {*−l}: <A5 B5 C11> (this class II knowledge could alternatively be represented as all items other than 1, or {i,j,m}: <A5 B5 C11>).

As shown in FIG. 15, the knowledge fragment K_{B} (including both class I and class II knowledge) is updated by the learned knowledge from replica A (which also contains both class I and class II knowledge). As replica A has star knowledge, when replica B synched with replica A, it received knowledge of all items in the collection. Any items it did not receive was because they were outside of replica B's interest set. For these items, class II knowledge may be sent to replica B as shown. However, given that replica A has star knowledge, the class II knowledge previously held in replica B may be discarded, and the updated knowledge fragment in replica B simplifies to replica B having knowledge of versions A3, B5, and C11 for all items in the collection: {*}: <A3 B5 C11>.

The ad hoc network shown in FIG. 4, possibly including one or more partial replicas, is able to perform sync operations in accordance with the embodiments described above. However, as described in the Background section, it may happen in certain synchronization topographies that replicas in the collection have filters which preclude sharing of items within the interest sets of two or more replicas. Accordingly, embodiments of the present system relate to a hierarchical approach to perform synchronization that provides guaranteed paths of information to all replicas in a collection. According to such an embodiment, each partial replica is assigned a preferred replica to act as a proxy on its behalf. This preferred replica is called the replica's “parent”. The partial replica regularly synchronizes with its parent as both source and target. The partial replica is said to be a “child” of its parent.

Parent replicas have filters which are either the same as, or more inclusive than, their children, and parent replicas thus store and synchronize all objects that are of interest to their one or more children replicas. Replicas avoid cyclic parent relationships by ensuring that they are not assigned one of their descendents as a parent. Reference replicas, however, are not required to pick parent replicas, although they must form a connected synchronization topology between them.

A “descendant” of a replica is any replica that is either (a) a child of that replica or (b) a descendant of a child of that replica. Likewise, an “ancestor” of a replica is a parent or an ancestor of a parent.

Referring to FIG. 5, information about a replica's location in the hierarchy is maintained in the replica's hierarchical information 122. Such information may include identification of parent replicas, identification of child replicas, identification of ancestor replicas, identification of descendant replicas, and the length of a chain of parents required to reach a reference replica.

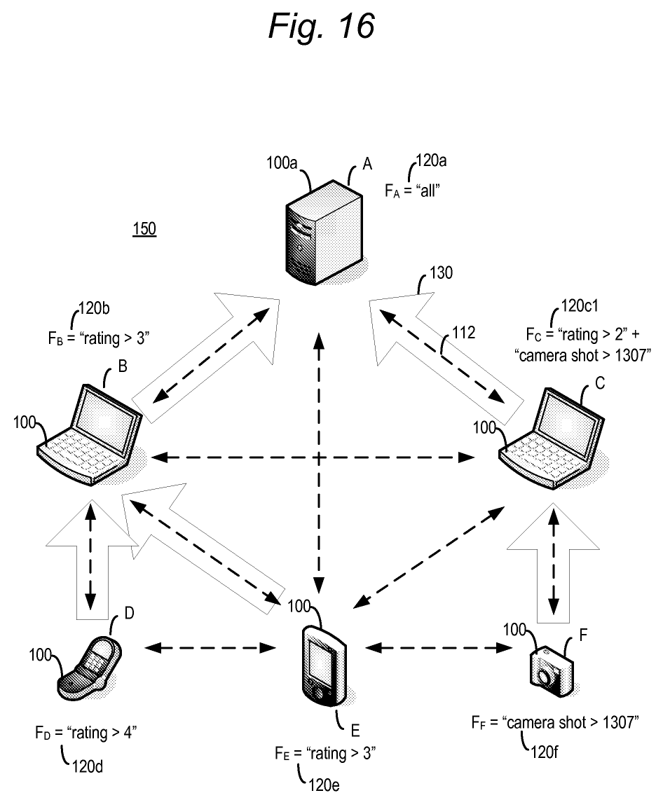

Referring now to FIG. 16, there is shown a hierarchical synchronization topology 150 for the example weakly consistent distributed collection of FIG. 4. The topology 150 includes a plurality of replicas 100 arranged in a hierarchy where each replica includes a parent except for a reference replica 100a, explained in greater detail hereinafter. The parent of each replica is indicated by a large arrow 130, which are based on a subset of the communication links 112. As shown, a given replica, such as replica C, may be both a parent replica (to replica F) and a child replica (to the reference replica A). A parent replica has a filter that is equal to or greater than the replicas it represents. As used herein, a filter indicates the items which are included in an interest set of a replica, as opposed to the filter indicating which items are excluded. In the topology 150 of FIG. 16, replica B having an interest set of items with “rating >3” is the parent of replicas D and E, which have interest sets of items with “rating >4” and “rating >3”, respectively. Reference replica A has an interest set of all items and is in turn the parent of replicas B and C.

In the embodiment shown in FIG. 16, most of the filters are relatively simple, and in many cases a first replica may compare its filter against the filter of a second replica to determine if the second replica has interest in a superset or subset of items of interest to the first replica. However, in the general case (a) the interest sets may not be comparable or (b) the comparison may not be feasible to compute. Accordingly, in embodiments, when a first replica acts as a parent of another replica, the first replica simply adds the filter of the second replica to its own filter. The second replica may in turn be a parent replica of one or more additional replicas, and have their filters in addition to its own filter. Thus, in the limit, the filter of a replica includes the filters of all its children, the children's children, and so on, recursively. For example in the embodiment shown in FIG. 16, laptop C is fundamentally interested only in photos with “rating >2” as is shown by its filter 120c in FIG. 4. But, in the hierarchical synchronization topology 150 of FIG. 16, laptop C serves as the parent of camera F, which has a filter “camera shot >1307”. Since “camera shot >1307” is incomparable to “rating >2”, laptop C must add the camera's filter to its own filter, producing the filter 120c1 shown in FIG. 16. In this way each parent replica guarantees to be interested in all items that any of its one or more children may be interested in.

In the case in which the parent replica is a reference replica, the parent does not need to bother about adding up the filters of its children. A reference replica is interested in all items, so it is guaranteed to be interested in any item that any of its children might be interested in.

For given ad hoc connections between replicas in a collection, the replicas may automatically establish themselves in embodiments in a hierarchical topology satisfying the above methodology. Alternatively, a user or administrator may designate one or more replicas as proxies and set up part or all of the hierarchical topology. The hierarchical topology augments, but does not replace, ad hoc synchronization. As shown in FIG. 16, in addition to the required sync operations between parent and child replicas indicated by the large arrows 130, replicas are still free to synchronize with arbitrary peers using any communication link 112.

At the top of the hierarchical topology are one or more reference replicas, such as replica A in FIG. 16. Reference replicas are complete replicas that are interested in all items in the collection. As explained hereinafter, partial replicas may create new items, which items work their way up the hierarchical topology through sync operations until a reference replica has a copy of the item, whereupon the item is disseminated to all reference replicas and then possibly down the hierarchical topology to any partial replica that is interested in the item. In order to ensure that each item is replicated throughout the weakly-consistent collection to all replicas that are interested in it, all partial replicas must sync with a reference replica, either directly, or as a descendent of a replica that has synched with a reference replica.

The hierarchical synchronization according to embodiments of the present system ensures two important properties of a replicated system: all replicas accumulate knowledge of items of interest and replicas are able to disseminate items to other replicas. Through a path of synchronizations between replicas organized in a hierarchy, a picture with rating >4 taken by camera F in FIG. 16 is guaranteed to be seen by cell phone D, and more generally, all items in a collection are guaranteed to be passed to replicas having an interest in such items.

New and updated items are propagated (and knowledge of such items is accumulated) up the hierarchical topology to a reference replica as a result of sync operations occurring between child and parent replicas in the hierarchy. Thus, in the example of FIG. 16, assume that replica E creates a new item, such as for example a photo with rating 4. At some time t₁, the parent replica B requests a sync with its child replica E, following the sync operation steps described above. According to the hierarchical rules, replica B will be interested in anything within replica E's interest set. During that sync operation, replica B learns of the new item, updates its data store with the new item and updates its knowledge to reflect that it has received this item.

At some later time t₂, the reference replica A requests a sync with its child replica B. As a reference replica, replica A is interested in every item. During that sync operation, reference replica A learns of the new item, updates its data store with the new item and updates its knowledge to reflect this new item. The example of FIG. 16 includes only one intermediate parent between a lowest level (most restrictive filter) replica and a top-level reference replica. However, it is understood that any number of levels of parents may exist between a lowest level replica and a reference replica, and that information will be accumulated in a reference replica by each replica in a hierarchical chain passing items upward to its parent.

By defining a hierarchical topology of one or more children synching with one or more parents as described above, it is guaranteed that all items created by any replica in the collection will eventually be assimilated into a reference replica. Once the hierarchical relationships are defined, synchronization of the parents to and from their one or more child replicas to pass new or updated items may occur by ad hoc synchronization; that is, by normal synchronization operations of proxies to their children that occur at times but according to no set schedule. However, in an alternative embodiment, synchronization of one or more children to and from their parent replica may be forced periodically according to a set schedule. The periodicity of this schedule may vary in alternative embodiments.

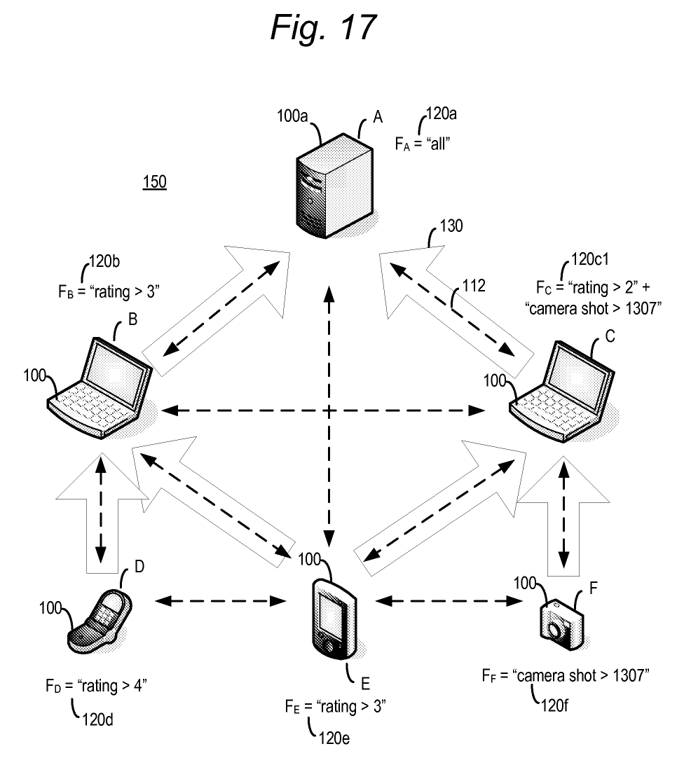

In the embodiment described in FIG. 16, each child selects a single parent to which the child's filter is added and with which the child syncs. However, it may happen that a parent replica may become unreachable for long periods of time. Accordingly, in a further embodiment of the present system shown in FIG. 17, a hierarchical topology may be provided based on directed acyclic graphs which allow a child replica to be assigned more than one parent replica. For example, in the embodiment of FIG. 17, replica E has both replicas B and C as its parent replicas.

In the simple embodiment of FIG. 17, an easy comparison of the filters of replicas C and E could be performed to verify that replica C can be a parent to replica E without having to increase replica C's filter. However, in embodiments, instead of a comparison of filters, the filter of replica E would be added to both replicas B and C, and a communication path 112 would be established between both replicas B and E and replicas C and E. In this way, the hierarchical topology would allow assimilation of information from replica E, and dissemination of information to replica E, by either or both of replicas B and C.

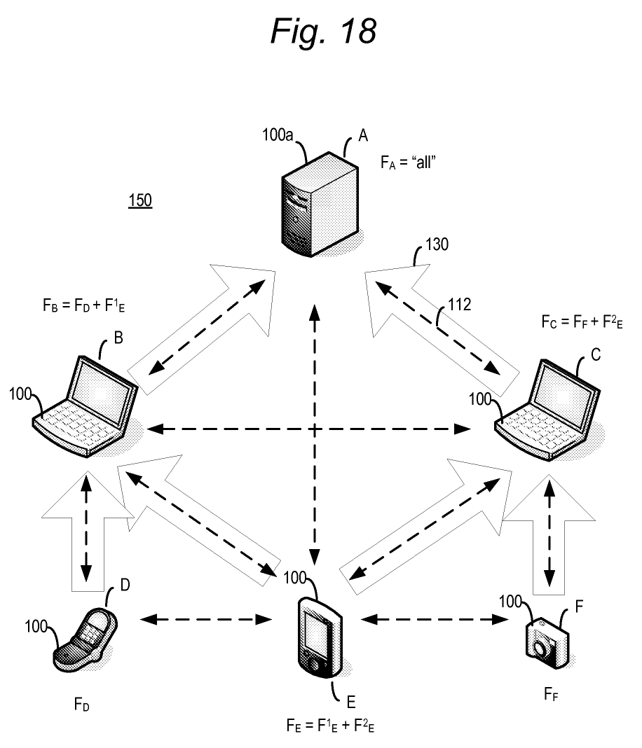

In order to account for high loads, an embodiment of the present system may operate using split filters in one or more of the replicas. For example, in the embodiment shown in FIG. 18, replica E splits its filter into two parts: F¹_{E} and F²_{E}. Replica E then selects two different proxy replicas (replicas B and C), each receiving one of replica E's sub-filters. This ensures that no single replica has to take the entire load of monitoring replica E's items. Moreover, it is conceivable that a replica's interest set may be derived from different, yet well known, sources. In such cases, it may be desirable to use split filters.

In embodiments of the hierarchical sync system, it may happen that an item is created by or modified within a partial replica so that it is outside of the interest set of the replica. This is called a “push-out.” Even though the partial replica is not interested in the new or updated item, since it holds the only copy it must keep it until it can guarantee that the item will eventually reach a reference replica. The replica can address this problem by maintaining that item in a “push-out” store that is managed independently from its data store. FIG. 5 shows a replica 100 with a push-out store 111. The purpose of the push-out store is to hold onto an item until the replica is assured that some other replica has assumed responsibility for the item. When an item is discarded from its push-out store, the replica may add the item to its class II knowledge.

The description hereinafter uses the following definitions. A replica “stores” a version of an item if either (a) the version is in the replica's data store, (b) the version is in the replica's push-out store, or (c) the version is superseded by a version that the replica “stores”. A replica “knows” a version of an item if either (a) the replica “stores” the version, (b) the replica is assured that the version falls outside the replica's filter, or (c) the version is superseded by a version that the replica “knows”. Roughly, versions that a replica “stores” are included in its class I knowledge and versions that a replica “knows” are included in its class I or class II knowledge.

In embodiments, a replica may include items in its push-out store in its class I knowledge, since they are items that it “stores”. Alternatively, a replica may include items in its push-out store in its class II knowledge, as items that it knows about but that fall outside its interest set.

Preferably, when a parent requests a sync with its child, the child replica sends push-out notifications of items to the parent replica and in this manner transfers responsibility for the items to its parent. Preferably, push-out notifications are sent for items in the child's push-out store. Alternatively, push-out notifications may also be sent for items in the child's data store. The push-out notification transfers the item regardless of whether or not it falls within the parent's interest set. If such a transferred item is outside of the parent's interest set, the parent likewise maintains the item in its own push-out store until it is able to transfer the item to its parent. Alternatively, push-out notifications could be sent from child to parent when the child initiates a sync or even independently of the ordinary sync protocol. The process of maintaining an item even if outside of the replica's filter continues until the item reaches a reference replica. In this way, updates made that are outside the filter(s) in a hierarchical chain will still reach a reference replica (which has no items outside its filter).

In alternative embodiments, a replica may send push-out notifications to any of the replica's ancestors. Alternatively, a replica may send push-out notifications to any replica that is closer to a reference replica, as indicated by comparing each replica's length of chain of parents, as maintained in a replica's hierarchical information. Note that when a replica receives a push-out notification, that replica receives responsibility for the item and must guarantee that the item eventually reaches a reference replica.

A push-out notification may include the item being transferred. In some embodiments, this is always the case. In alternative embodiments, if the sending replica determines that the receiving replica already “stores” the item, the push-out notification may be abbreviated to include the identifier and version of the item being transferred and need not include the item itself. Preferably, the sending replica determines this by inspecting class I knowledge sent by the receiving replica during the normal synchronization protocol. Alternatively, the information could be sent in a separate protocol.

In further embodiments, a replica R can manage push-outs more efficiently by associating an explicit “responsibility bit” with each item. The responsibility bit of an item is set at replica R when the item is generated by R either for the first time or through an update of an older version of that item. When the item falls outside R's interest set, either as a result of the previous update or as a result of a change in R's filter, the item is transferred to the push out store of R if its responsibility bit is set and simply discarded otherwise. R may send a push-out notification for item i only when the responsibility bit for item is set. When this happens, R clears the responsibility bit and the receiving replica sets it. In addition, R clears the responsibility bit for item i whenever it receives an updated version of item i or a move-out notification for item i. If item i is in a push-out store when its responsibility bit is cleared, item i may be discarded.

New and updated items are disseminated from a reference replica down the hierarchical topology as a result of sync operations occurring between parent replicas and their children in the hierarchy. For example, referring again to FIG. 16, at some time t₃, replica C requests a sync from its parent, reference replica A, following the sync operation steps described above. As shown in Table 3 discussed above, when a child replica syncs from an up to date reference replica, the knowledge in the child replica is updated to the knowledge of the reference replica. It may be that the child replica has more up to date information regarding one or more items. In this case, the knowledge fragments in the child replica are updated per Table 3.

When syncing from reference replica A, replica A may send both class I and class II knowledge as learned knowledge. However, as shown and described above with respect to FIG. 15, because replica C receives knowledge from reference replica A of all items (some of which may be within replica C's interest set and some of which may be outside replica C's interest set), there is no need to maintain class II knowledge as a separate knowledge fragment, and the class II knowledge fragment may be discarded, as in FIG. 15. Replica C is left with a single “star knowledge” fragment.

Subsequently, replica F may sync from replica C, in a manner described above, and thus, all knowledge that was known to the reference replica and fitting replica F's interest set may be learned by replica F. In general, the children replicas may sync from their parent replicas as described above until all knowledge from the reference replica is received in the bottom tier replicas. In this way, all updates made by any replicas are received in all other replicas having interest in those updates.

By defining a hierarchical topology of one or more children synching with one or more parents as described above, it is guaranteed that all items created by any replica in the collection will eventually be disseminated. Once the hierarchical relationships are defined, synchronization of the children to and from their parents may occur by ad hoc synchronization. However, in an alternative embodiment, synchronization of one or more children to and from their parent replica may be forced periodically according to a set schedule. The periodicity of this schedule may vary in alternative embodiments.

The process of assimilation and dissemination of knowledge may occur during a single synchronization operation between a child and its parent. That is, the synchronization operation may be a two-way sync operation where the parent assimilates the knowledge of the child replica, and the parent disseminates its knowledge to the child replica. However, it is understood that the assimilation and dissemination of knowledge between children replicas and parent replicas may occur in separate, one-way sync operations.

At times, it may be desired to change the parent of a partial replica. In the hierarchical topology of the present system, the filter of the new parent may have to be enlarged in order to guarantee that the new parent has an interest set that contains the interest set of the partial replica. After the old parent has lost the child, it may be possible to reduce the filter of the old parent.

At times, it may be desired to change the filter of a partial replica. If the change is a reduction, then no change to the filter of its parent is required, although subsequently the parent could in turn be permitted to reduce its filter accordingly. Alternatively, the parent replica must change its filter in order to accommodate the new filter of its child. This may require the parent to have its parent change its filter, and so on. Alternatively, the partial replica can be assigned to a new parent.

At times, it may be desirable to add replicas to a collection. In the hierarchical topology of the present system, given a proposed new replica having some proposed filter, the situation is analogous to changing the parent of an existing replica, except in this case there is no old parent. A partial replica could always be assigned a reference replica as a parent.

Hierarchical synchronization enables the present replication system to defragment a replica's knowledge and represent it using fewer knowledge fragments.

Star knowledge reduces the number of item set knowledge fragments maintained by a replica because it subsumes other knowledge fragments. Any item set knowledge fragment in the replica's knowledge that is dominated by star knowledge is subsumed by the star knowledge and need not be maintained. Alternatively, all item set knowledge fragments in the replica's class I knowledge that are dominated by star knowledge can be combined into a single class I item-set knowledge fragment equal to the star knowledge. Thus, a replica can reduce the number of knowledge fragments as its star knowledge increases. In the long run, a replica might even be able to reduce its entire knowledge to a single star knowledge fragment.

An embodiment of the present replication system that uses a non-split hierarchical synchronization topology can increase the star knowledge of a replica through synchronization from its descendant and ancestor replicas according to the method described below. This method works for embodiments in which no replica ever changes its filter so as to become more inclusive.

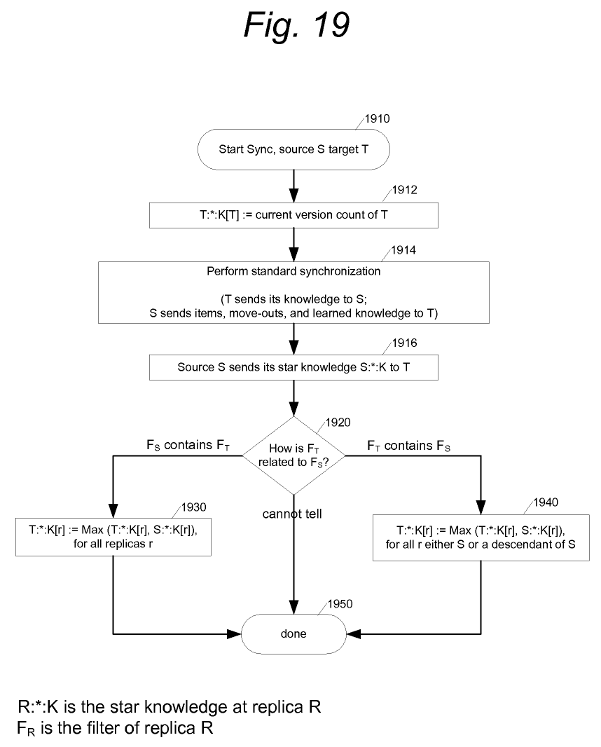

Referring to FIG. 19, which gives an exemplary flowchart of this method, at step 1910 a target replica T has decided to request a sync from source replica S. In step 1912, replica T updates its star knowledge by adjusting its own component version number to be the most recent version number it has issued. In step 1914 replica T performs a standard synchronization as the target with replica S as the source. Then, in step 1916, S sends its star knowledge to T. In step 1920, replica T determines the relationship between its filter F_{T} and S's filter F_{S}. If there is a hierarchical relationship between S and T, then the relationship between the filters can be easily determined. If F_{T} contains F_{S}, then in step 1940 T updates its star knowledge with the components of S's star knowledge corresponding to S and all of S's descendants, after which the method is finished at step 1950. Otherwise, if F_{S} contains F_{T}, then in step 1930 T updates its star knowledge with the components of S's star knowledge corresponding to all replicas, after which the method is finished at step 1950. Finally, if the filters are incomparable or their relationship cannot be determined, then the method is finished at step 1950. Note that replica T updates its star knowledge from S only after all necessary updates have been received from S during the synchronization.

The above method for increasing star knowledge only applies to embodiments of the present system in which no replica ever changes its filter so as to become more inclusive. Alternative embodiments of the present system in which a replica might change its filter, without concern for whether the change increases or decreases the filter, can use the method described below.

An alternative embodiment of the present replication system that uses a non-split hierarchical synchronization topology can increase the star knowledge of a replica through synchronization from its descendant and ancestor replicas according to the method described below. This method works for embodiments in which replicas change their filters without concern for whether the change increases or decreases the filter. However, this method requires that each replica always “stores” every version generated by it or any of its descendants. In an embodiment of the system employing this method a replica can fulfill this requirement by simply adding to its filter all items created or updated by itself. In such an embodiment, note that the hierarchical relationship of replicas ensures that a replica implicitly also “stores” every version generated by any of its descendants.

Recall that when a replica changes its filter and the new filter might be more inclusive than the old filter, the replica needs to discard all its class II knowledge fragments. In addition, when using star knowledge, the replica also needs to change its star knowledge since the star knowledge also implicitly represents class II knowledge. The required change is as follows. The replica must set to zero those components of its star knowledge corresponding to all replicas other than itself and its descendants. Further updates to star knowledge as a result of synchronization happen in the same way as described in the previous method and illustrated in FIG. 19.

FIG. 20 illustrates an example of a suitable general computing system environment 400 for implementing a replica. It is understood that the term “computer” as used herein broadly applies to any digital or computing device or system. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 20, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 20 illustrates operating system 434, application programs 435, other program modules 436, and program data 437.

The computer 410 may also include other removable/non-removable, volatile/nonvolatile computer storage media. By way of example only, FIG. 20 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440. Magnetic disc drive 451 and optical media reading device 455 are typically connected to the system bus 421 by a removable memory interface, such as interface 450.

The drives and their associated computer storage media discussed above and illustrated in FIG. 20, provide storage of computer readable instructions, data structures, program modules and other data for the computer 410. In FIG. 20, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 20. The logical connections depicted in FIG. 20 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 20 illustrates remote application programs 485 as residing on memory device 481. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of synchronizing a plurality of replicas having a plurality of items in a weakly consistent distributed collection, the method comprising the steps of:
(a) establishing a first partial replica in the weakly consistent distributed collection, the first partial replica having filter defining a first interest set of items including less than all of the items in the plurality of items;
(b) establishing a second partial replica in the weakly consistent distributed collection, the second partial replica having filter defining second interest set of items including less than all of the items in the plurality of items, the first interest set of the first replica and the second interest set of the second replica sharing at least one item in common from the plurality of items; and
(c) guaranteeing a synchronization path between the first and second replicas.

2. A computer implemented method as recited in claim 1, further comprising the steps of:
(d) establishing one or more parent replicas in the weakly consistent distributed collection, the one or more parent replicas each having a filter defining an interest set of items that is the same as or less restrictive than the filter of the first partial replica; and
(e) guaranteeing a synchronization path between the first partial replica and the one or more parent replicas.

3. A computer implemented method as recited in claim 2, wherein said step (d) of establishing one or more parent replicas in the weakly consistent distributed collection comprises the step of establishing multiple parent replicas.

4. A computer implemented method as recited in claim 3, wherein the filter of the first partial replica is a split filter divided into first and second sub-filters, the first partial replica synchronizing with a first parent replica of the multiple parent replicas for items in the interest set of the first sub-filter, and the first partial replica synchronizing with a second parent replica of the multiple parent replicas for items in the interest set of the second sub-filter.

5. A computer implemented method as recited in claim 1, further comprising the step (e) of maintaining a push-out store in the first partial replica, the push-out store maintaining an item that has changed from within the first interest set to be outside of the first interest set.

6. A computer implemented method as recited in claim 5, the weakly consistent distributed collection further including a parent replica having a synchronization path with the first partial replica, and having a filter defining an item set that is the same as or less restrictive than the first partial replica, the method further comprising the step (f) of the first partial replica notifying the parent replica of the item in the push-out store of the first partial replica.

7. A computer implemented method as recited in claim 6, the weakly consistent distributed collection further including a grandparent replica having a synchronization path with the parent replica, and having a filter defining an item set that is the same as or less restrictive than the parent replica, the method further comprising the step (g) of the parent replica notifying the grandparent replica of the push-out notification the parent received in said step (f).

8. A computer implemented method as recited in claim 6, the weakly consistent distributed collection further including a reference replica having an interest set including all items in the plurality of items and a synchronization path to the first partial replica by one or more intermediate replicas including the parent replica, the method further comprising the step (h) of the reference replica receiving notification of the item in the push-out store of the first partial replica via the one or more intermediate replicas.

9. A computer implemented method as recited in claim 6, the weakly consistent distributed collection further including a reference replica having an interest set including all items in the plurality of items, the method further comprising the step (i) of the first partial replica notifying a given replica in the collection that is not a parent replica of the first partial replica, the given replica having a synchronization path to the reference replica.

10. A computer implemented method as recited in claim 5, the weakly consistent distributed collection further including a parent replica having a synchronization path with the first partial replica, and having a filter defining an item set that is the same as or less restrictive than the first partial replica, the method further comprising the steps of:
(j) the first partial replica determining whether the item in the push-out store is within the interest set of the parent replica; and
(k) the first partial replica sending an identification and version of the item in the push-out store if it is determined in said step (j) that the item in the push-out store is within the interest set of the parent replica.

11. A computer implemented method as recited in claim 5, wherein said step (e) of maintaining an item in the push-out store comprises the steps:
(e1) setting a responsibility bit for an item when the item is created or updated by the first partial replica; and
(e2) storing the item in the push-out store when the item falls outside of the first partial replica's interest set only if the responsibility bit for the item is set in said step (e1).

12. A computer implemented method as recited in claim 11, the weakly consistent distributed collection further including a parent replica having a synchronization path with the first partial replica, and having a filter defining an item set that is the same as or less restrictive than the first partial replica, the method further comprising the step (f) of the first partial replica notifying the parent replica of the item in the push-out store of the first partial replica only if the responsibility bit for the item is set in said step (e1).

13. A computer implemented method of synchronizing a plurality of replicas having a plurality of items in a weakly consistent distributed collection, the method comprising the steps of:
(a) defining a first filter in a first replica of the plurality of replicas, the first filter defining an interest set of items for the first replica;
(b) defining a second filter in a second replica of the plurality of replicas, the second filter defining an interest set of items for the second replica and the second filter being the same as or more inclusive than the first filter;
(c) guaranteeing a synchronization path between the first replica and the second replica;
(d) defining a third replica of the plurality of replicas to have knowledge of all items in the collection;
(e) requiring a synchronization path between the second replica and the third replica; and
(f) allowing ad hoc synchronization between the plurality of replicas in the weakly consistent distributed collection.

14. A computer implemented method as recited in claim 13, wherein the weakly consistent distributed collection includes a fourth replica having a synchronization path with the first replica, and having a filter being the same as or more inclusive than the first filter, and wherein the first filter of the first replica is a split filter divided into first and second sub-filters, the first replica synchronizing with the second replica for items in the interest set of the first sub-filter, and the first replica synchronizing with a fourth replica for items in the interest set of the second sub-filter.

15. A computer implemented method as recited in claim 13, further comprising the step (g) of maintaining a push-out store in the first replica, the push-out store maintaining an item that has changed from within the first interest set to be outside of the first interest set.

16. A computer implemented method as recited in claim 15, further comprising the step (h) of the first replica notifying the second replica of the item in the push-out store of the first replica.

17. A collection of replicas having knowledge of items, the replicas communicating with each other in a weakly-consistent distributed ad hoc network, the collection of replicas comprising:
a reference replica having an interest set including all items in the collection;
a first replica having a filter indicating an interest set of items the first replica receives;
a proxy replica having a filter defined to include at least a portion of the filter of the first replica, a guaranteed synchronization pathway existing between the first replica and the proxy replica and between the proxy replica and the reference replica allowing knowledge of the first replica to be shared with the reference replica and allowing knowledge of the reference replica to be shared with the first replica.

18. A collection of replicas as recited in claim 17, wherein the plurality of replicas ensure that a modification to an item is passed from the modifying replica to the reference replica via a synchronization path including one or more intermediate replicas regardless of whether the modified item is inside or outside of the filters of the intermediate replicas.

19. A collection of replicas as recited in claim 17, wherein the proxy replica comprises a first proxy replica, the collection of replicas further comprising a second proxy replica having a filter defined to include at least a portion of the filter of the first replica, a guaranteed synchronization pathway existing between the first replica and the second proxy replica and between the second proxy replica and the reference replica.

20. A collection of replicas as recited in claim 18, the filter in the first replica comprising a first sub-filter and a second sub-filter, the first proxy replica including the first sub-filter and the second proxy replica including the second sub-filter.
